(19) United States
(12) Patent Application Publication
(10) Pub. No.: US 2025/0237154 A1
(43) Pub. Date: Jul. 24, 2025

(54) IMPELLER CONTAINMENT SYSTEM

(71) Applicant: PRATT & WHITNEY CANADA CORP., Longueuil (CA)

(72) Inventors: Hamid KHORRAMI, Longueuil (CA); Michael FRYER, Oakville (CA); Jeffrey Bernard HEYERMAN, Oakville (CA); Amir Masoud TAHVILIAN, Mississauga (CA)

(21) Appl. No.: 18/420,127

(22) Filed: Jan. 23, 2024

(51) Int. Cl. F01D 21/04; F01D 25/26

(52) U.S. Cl. CPC F01D 21/045; F01D 25/26; F05D 2220/323; F05D 2240/14

(57) ABSTRACT

An aircraft engine includes an air inlet and a compressor section receiving air therefrom. The compressor section has a centrifugal impeller mounted for rotation about an axis and having a hub, and an outer shroud extending radially outwardly of the hub, defining an annular flow path. The shroud at least partially surrounds the hub. Blades extend radially outwardly from the hub and rotate within the flow path. An air inlet case has a radially outer wall extending from the inlet to the shroud and a radially inner wall extending from the inlet to the hub. An annular passage is defined between the walls, fluidly coupling the inlet to the impeller. The outer wall includes a frangible element adjacent a junction between the outer wall and the shroud. The frangible element extends about an outer circumference of the outer wall and frangibly connects the outer wall to the shroud.

### TECHNICAL FIELD

The disclosure relates generally to aircraft engines, and, more particularly, to a containment system for containing impeller fragments.

### BACKGROUND

Aircraft engines and auxiliary power units are known to include turbines and compressors which rotate at high rotational speeds. Aviation regulations typically require engine manufacturers to demonstrate fragments containment following a specified burst event. While known containment structures may be suitable for their intended purposes, aviation safety is paramount and therefore improvements are always desirable.

### SUMMARY

In one aspect, there is provided an aircraft engine, comprising: an air inlet; a compressor section for receiving air from the air inlet, the compressor section having a centrifugal impeller mounted for rotation about an axis and an outer shroud, the centrifugal impeller including an impeller hub, the outer shroud extending radially outwardly of the impeller hub to define an annular flow path radially between the impeller hub and the outer shroud, the outer shroud at least in part surrounding the impeller hub, and blades extending radially outwardly from the impeller hub and operable to rotate within the annular flow path; and an air inlet case having a radially outer wall extending from the air inlet to the outer shroud and a radially inner wall extending from the air inlet to the impeller hub, an annular passage defined radially between the radially outer wall and the radially inner wall fluidly coupling the air inlet to the centrifugal impeller, the radially outer wall including a frangible element adjacent a junction between the radially outer wall and the outer shroud, the frangible element extending about an outer circumference of the radially outer wall and frangibly connecting the radially outer wall to the outer shroud.

In another aspect, there is provided an impeller containment system, comprising: an impeller having an impeller hub and a set of blades extending radially outwardly from the impeller hub; an outer shroud extending radially outwardly of the impeller to define an annular flow path radially between the impeller hub and the outer shroud; and an air inlet case having a radially outer wall operatively coupled to the outer shroud and a radially inner wall operatively coupled to the impeller hub, an annular passage defined radially between the radially outer wall and the radially inner wall to fluidly couple the centrifugal impeller to an upstream air inlet, the radially outer wall including a frangible element adjacent a junction between the radially outer wall and the outer shroud, the frangible element operable to detach at an occurrence of an impeller burst event to interrupt a load path between the impeller and the air inlet case.

In a further aspect, there is provided a method of limiting load transmission to an air inlet case of an aircraft engine upon bursting of a centrifugal compressor impeller of the aircraft engine, the method comprising: at least partially surrounding the centrifugal compressor impeller with a radially outer shroud; and frangibly attaching the radially outer shroud to the air inlet case, such that the radially outer shroud is detached from the air inlet case under a load impact of the centrifugal impeller bursting during operation of the aircraft engine.

### BRIEF DESCRIPTION OF THE DRAWINGS

Reference is now made to the accompanying figures in which:

FIG. 1 is a schematic cross-section view of a turboshaft engine comprising a compressor impeller containment system;

FIG. 2 is a schematic cross-sectional view of the impeller containment system;

FIG. 3 is an enhanced schematic cross-sectional view of the impeller containment system; and

FIG. 4 is a schematic cross-sectional view of the impeller containment system of FIG. 2 following an impeller burst event.

### DETAILED DESCRIPTION

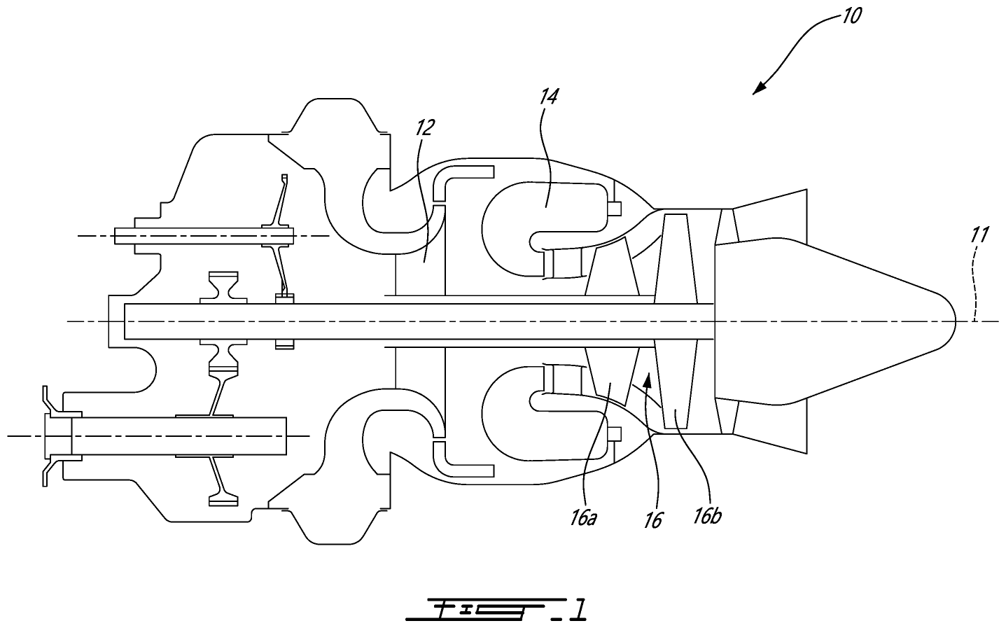

FIG. 1 illustrates a turboshaft engine 10 suitable for use as an auxiliary power unit (APU) of an aircraft. The engine 10 generally comprises in serial flow communication, a compressor section 12 for pressurizing the air, a combustor 14 in which the compressed air is mixed with fuel and ignited for generating an annular stream of hot combustion gases, and a turbine section 16 for extracting energy from the combustion gases.

The engine 10 in this example can be seen to include a high pressure spool including an impeller assembly 20 and a high-pressure turbine 16a, and a low pressure spool including a low-pressure turbine 16b. The low spool leads to a power shaft via a gear arrangement. The high pressure spool can be refer to herein as a compressor spool and the low spool can be referred to herein as the power spool.

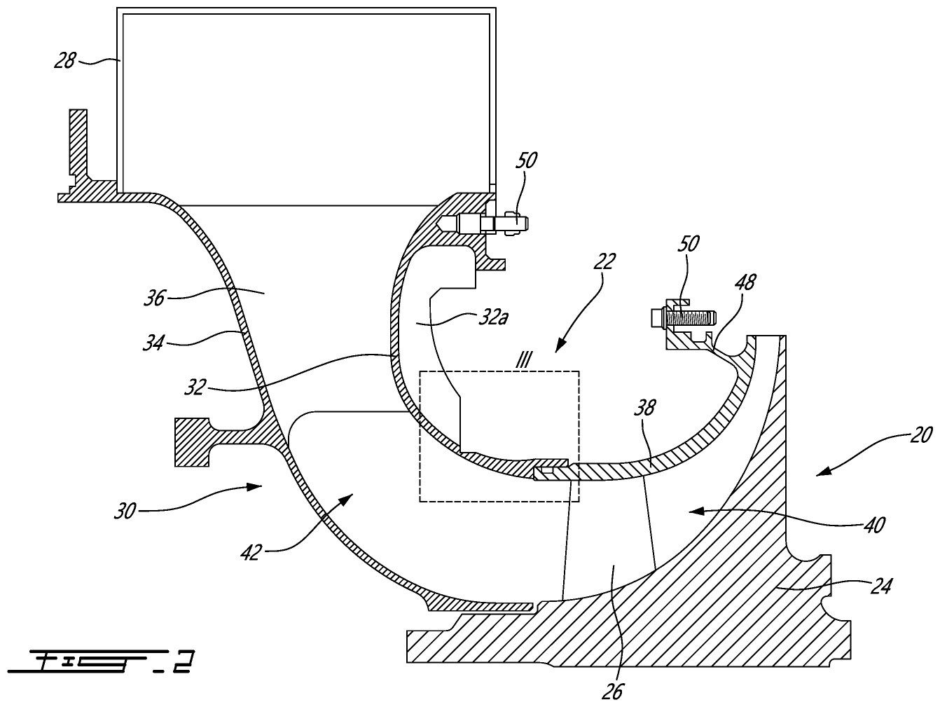

Referring to FIG. 2, the impeller assembly 20 and an impeller containment assembly 22 (also referred to as an impeller containment system) are shown. The impeller assembly 20 comprises a centrifugal impeller adapted to be mounted to an impeller drive shaft (not shown). The centrifugal impeller comprises an annular impeller hub 24 attached to the drive shaft to be rotated thereby, and an annular series of impeller blades 26 integrally connected to the annular impeller hub 24. The impeller drive shaft may extend in parallel with a central longitudinal axis 11 of the engine 10. Air from an air inlet 28 is directed to the impeller assembly 20 by way of an air inlet case 30 having a first or radially outer wall 32 and a second or radially inner wall 34. The first and second walls 32, 34 each have a frustoconical portion with an upstream radial component beginning at the air inlet 28 and transitioning to a downstream axial component terminating at the impeller assembly 20. The first and second walls 32 are spaced apart to define an annular space or annular passage 42 between the first and second walls 32, 34, the annular passage 42 acting as a passage for the air from the air inlet 28 to the impeller assembly 20. The air inlet case 30 is operatively coupled to the air inlet 28 at an upstream end thereof, illustratively via one or more fasteners 50, and to the impeller assembly at a downstream end thereof. One or more guide vanes 36 may be provided within the air inlet case 30 between the walls 32, 34 to direct air from the air inlet 28 to the impeller assembly 20. In the shown embodiment, but not necessarily the case in all embodiments, the first wall 32 includes ribbing 32a (and may thus be referred to as a ribbed wall).

The impeller assembly 20 includes an outer shroud 38 extending radially outwardly of the impeller assembly 20. The outer shroud 38 surrounds, at least partially, the impeller assembly 20. A space between the impeller hub 24 and the outer shroud 38 defines part of an annular flow path 40 of the engine 10, with the impeller blades 26 extending across that flow path 40. Illustratively, the outer shroud 38 is operatively coupled to the first wall 32 at the upstream end of the flow path 40, while the second wall 34 is operably interfaced to the impeller hub 24, thereby fluidly coupling the annular flow path 40 to the annular passage 42 defined between the radially outer wall 32 and the radially inner wall 34, the annual passage 42 thereby fluidly coupling the air inlet 28 to the impeller assembly 20.

In the occurrence of an impeller burst event, for instance an impeller tri-hub burst event, various aviation requirements may require the one or more released fragments to be contained. For instance, if an impeller were to burst into multiple pieces (e.g., three pieces in the context of a tri-hub burst event), lobes should be contained within the surrounding structure, and energy should be absorbed to preserve the structural integrity of the surrounding parts. As the impeller burst energy is typically absorbed by the surrounding structural parts, it may impose high dynamic loads on these parts. In the shown case, in the context of a burst event within the impeller assembly 20, radial expansion emanating from the burst hub 24 and/or blades 26 may push the impeller shroud 38 in a radially outward direction. The shroud 38 may be prevented from expanding radially outwardly due to the presence of surrounding engine components (e.g., a diffuser downstream of the impeller assembly 20). As such, the load may propagate axially, for instance in an axially upstream direction relative to air flowing along the annular passage 42 along a load path extending from the shroud 38 to the air inlet 28 by way of the radially outer wall 32.

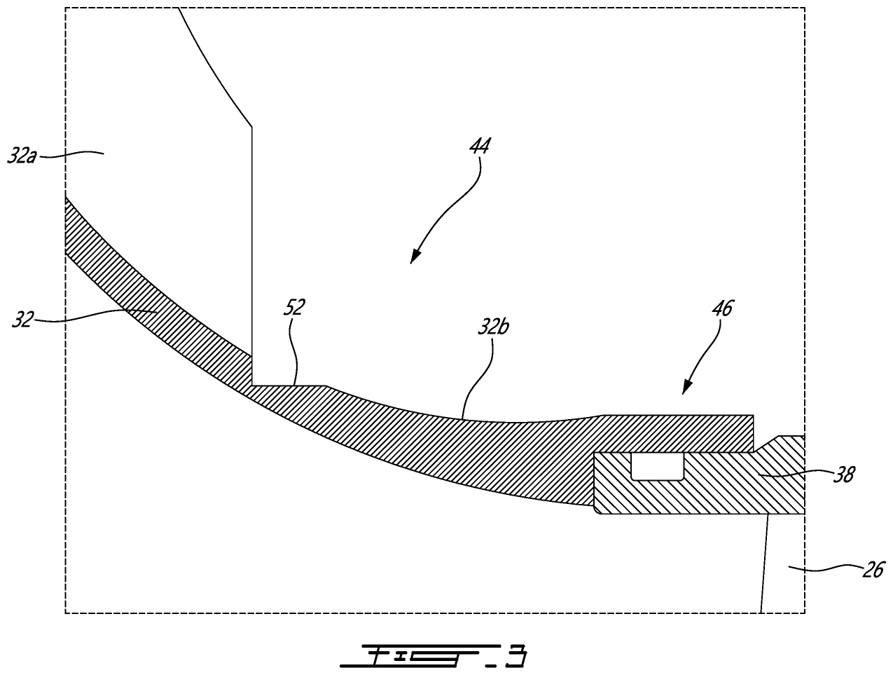

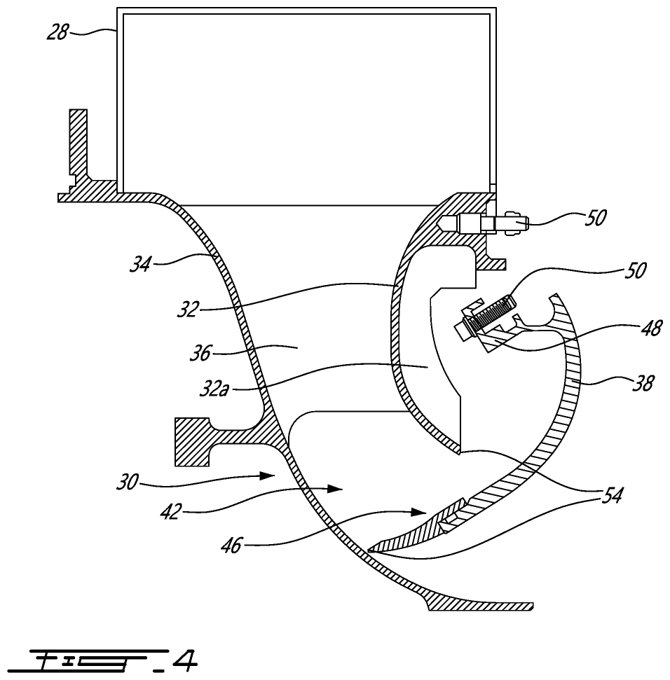

Referring to FIGS. 2 and 3, the containment assembly 22 includes a frangible element 44 disposed in the radially outer wall 32 adjacent a junction 46, also referred to as an interface, between the radially outer wall 32 and the shroud 38, the frangible element 44 thereby frangibly attaching the radially outer wall 32 to the shroud 38. The location of the frangible element 44 on the radially outer wall 32 may vary. For instance, in the shown case, the frangible element 44 is disposed immediately downstream of a transition between a radially-extending segment and an axially-extending segment of the radially outer wall 32. Other locations for the frangible element 44 may be contemplated, for instance aligned radially aligned with the guide vane 36. Following an impeller burst event, a high axial load may be transferred to the air inlet 28 through the radially outer wall 32. To mitigate any potential damage to the air inlet case 30 and/or other surrounding components, the frangible element 44 is operable to break, separate or detach at the occurrence of a burst event (i.e., under a predetermined load impact). As such, and as shown in FIG. 4, the separated portion (illustratively including a portion of the radially outer wall 32 and the shroud 38) may become trapped within the air inlet case 30 (illustratively abutting the radially inner wall 34 within the annular passage 42), acting as a stopper for any fragments dislodged as a result of the burst event (thereby preventing from any fragments from traveling upstream towards, and potentially damaging, the air inlet 28). Axial loads resulting from the burst event, and any cracks stemming therefrom, may thus be prevented from travelling upstream towards the air inlet 28. In addition, a bolted flange 48 of the shroud 38 (e.g., securing the shroud 38 to an adjacent component, illustratively via fastener(s) 50) may be prevented from impacting and potentially damaging the air inlet 28.

Referring back to FIG. 3, the shown frangible element 44 includes a circumferential groove or recess 52 in a radially outer surface 32b of the radially outer wall 32 axially adjacent the junction 46 between the radially outer wall 32 and the shroud 38. The circumferential groove 52 extends about an outer circumference of the radially outer wall 32. In some cases, the circumferential groove 52 may be continuous, i.e., is circumferentially uninterrupted, about the outer circumference of the radially outer wall 32. In other cases, the circumferential groove 52 may be formed of a plurality of circumferentially-arranged recessed portions about the outer circumference of the radially outer wall 32. Other arrangements may be contemplated, for instance one or more cutouts, or a selective removal of material, in the radially outer wall 32 in lieu of recess(es). The frangible element 44 is thus structurally weaker than a remainder of the radially outer wall 32, for instance by having a lesser radial thickness than a remainder of the radially outer wall 32, to promote separation from the remainder of the radially outer wall 32 upon a burst event. As discussed above, in the shown case, but not necessarily the case in all embodiments, the radially outer wall 32 includes ribbing 32a protruding from the radially outer surface of the radially outer wall 32, for instance to provide additional stiffness to the air inlet case 30. In such cases, the ribbing 32a may terminate axially upstream of the frangible element 44 so that the additional stiffness provided by the ribbing 32a does not affect the structural weakness of the frangible element 44. In other cases, the ribbing 32a may be omitted. In the shown embodiment, although not necessarily the case in all embodiments, the ribbing 32a terminates immediately upstream of the frangible element 44.

Referring again to FIG. 4, following a burst event, the frangible element 44, upon receiving a predetermined axial load from the outer shroud 38, may detach or separate at a detachment point 54. The axial load from the outer shroud 38 may direct or push the outer shroud 38 in an axially upstream direction towards the radially inner wall, forming a blockage or stop within the annular passage 42 to prevent released fragments from traveling upstream towards the air inlet 28.

According to the present disclosure, there is taught a method of limiting load transmission to an air inlet case of an aircraft engine upon bursting of a centrifugal compressor impeller of the aircraft engine. The centrifugal compressor impeller is at least partially surrounded with a radially outer shroud. The radially outer shroud is frangibly attached to the air inlet case, such that the shroud is detached from the air inlet case under a load impact of the centrifugal impeller bursting during operation of the engine.

In some embodiments, the frangibly attaching of the radially outer shroud to the air inlet case includes selectively removing material from the air inlet case adjacent an interface between the outer shroud and the air inlet case.

In some embodiments, the frangibly attaching includes forming a groove about a radially outer surface of the air inlet case, for instance by way of 3D printing.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the following description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. An aircraft engine, comprising:
an air inlet;
a compressor section for receiving air from the air inlet, the compressor section having a centrifugal impeller mounted for rotation about an axis and an outer shroud, the centrifugal impeller including an impeller hub, the outer shroud extending radially outwardly of the impeller hub to define an annular flow path radially between the impeller hub and the outer shroud, the outer shroud at least in part surrounding the impeller hub, and blades extending radially outwardly from the impeller hub and operable to rotate within the annular flow path; and
an air inlet case having a radially outer wall extending from the air inlet to the outer shroud and a radially inner wall extending from the air inlet to the impeller hub, an annular passage defined radially between the radially outer wall and the radially inner wall fluidly coupling the air inlet to the centrifugal impeller, the radially outer wall including a frangible element adjacent a junction between the radially outer wall and the outer shroud, the frangible element extending about an outer circumference of the radially outer wall and frangibly connecting the radially outer wall to the outer shroud.

2. The aircraft engine as defined in claim 1, wherein the frangible element is structured such that, upon a burst event at the centrifugal impeller, the frangible element separates with the outer shroud and displaces axially towards the radially inner wall.

3. The aircraft engine as defined in claim 1, wherein the frangible element is recessed in a radially outer surface of the radially outer wall.

4. The aircraft engine as defined in claim 1, wherein the frangible element is a circumferential groove extending about the outer circumference of the radially outer wall.

5. The aircraft engine as defined in claim 4, wherein the circumferential groove extends circumferentially uninterruptedly along the outer circumference of the radially outer wall.

6. The aircraft engine as defined in claim 1, wherein the radially outer wall includes ribbing along its outer circumference, the ribbing terminating axially upstream of the weakening element relative to a flow of air through the annular passage.

7. The aircraft engine as defined in claim 1, wherein the frangible element includes a plurality of circumferentially arranged recesses about the outer circumference of the radially outer wall.

8. The aircraft engine as defined in claim 1, wherein the frangible element includes one or more circumferentially arranged cutouts through the radially outer wall.

9. An impeller containment system, comprising:
an impeller having an impeller hub and a set of blades extending radially outwardly from the impeller hub;
an outer shroud extending radially outwardly of the impeller to define an annular flow path radially between the impeller hub and the outer shroud; and
an air inlet case having a radially outer wall operatively coupled to the outer shroud and a radially inner wall operatively coupled to the impeller hub, an annular passage defined radially between the radially outer wall and the radially inner wall to fluidly couple the centrifugal impeller to an upstream air inlet, the radially outer wall including a frangible element adjacent a junction between the radially outer wall and the outer shroud, the frangible element operable to detach at an occurrence of an impeller burst event to interrupt a load path between the impeller and the air inlet case.

10. The impeller containment system as defined in claim 9, wherein the frangible element extends about an outer circumference of the radially outer wall and frangibly attaches the radially outer wall to the outer shroud.

11. The impeller containment system as defined in claim 9, wherein, upon the burst event the outer shroud is operable to displace axially towards the radially inner wall.

12. The impeller containment system as defined in claim 9, wherein the frangible element is recessed in a radially outer surface of the radially outer wall.

13. The impeller containment system as defined in claim 9, wherein the frangible element includes a circumferential groove extending about an outer circumference of the radially outer wall.

14. The impeller containment system as defined in claim 13, wherein the circumferential groove extends circumferentially uninterruptedly along the outer circumference of the radially outer wall.

15. The impeller containment system as defined in claim 9, wherein the radially outer wall includes ribbing along its outer circumference, the ribbing terminating axially upstream of the weakening element relative to a flow of air through the annular passage.

16. The impeller containment system as defined in claim 9, wherein the frangible element includes a plurality of circumferentially arranged recesses about an outer circumference of the radially outer wall.

17. The impeller containment system as defined in claim 9, wherein the frangible element includes one or more circumferentially arranged cutouts through the radially outer wall.

18. A method of limiting load transmission to an air inlet case of an aircraft engine upon bursting of a centrifugal compressor impeller of the aircraft engine, the method comprising:
at least partially surrounding the centrifugal compressor impeller with a radially outer shroud; and
frangibly attaching the radially outer shroud to the air inlet case, such that the radially outer shroud is detached from the air inlet case under a load impact of the centrifugal impeller bursting during operation of the aircraft engine.

19. The method as defined in claim 18, wherein the frangibly attaching the radially outer shroud to the air inlet case includes selectively removing material from the air inlet case adjacent an interface between the radially outer shroud and the air inlet case.

20. The method as defined in claim 19, wherein the frangibly attaching includes forming a groove about a radially outer surface of the air inlet case.
